(19) United States
(12) Patent Application Publication
(10) Pub. No.: US 2006/0137993 A1
(43) Pub. Date: Jun. 29, 2006

(54) Process method for achieving uniform stress free electro-polishing across a copper plated wafer

(75) Inventors: Steven Reder, Boring, OR (US); Michael Berman, West Linn, OR (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/359,734

(22) Filed: Feb. 22, 2006

Related U.S. Application Data
(62) Division of application No. 10/454,944, filed on Jun. 5, 2003.

(51) Int. Cl. B23H 3/00

(52) U.S. Cl. 205/652

(57) ABSTRACT

A method of electro-polishing a copper plated wafer. The method includes providing an opening which is at least as long as the copper plated wafer. The method includes dispensing an electrolyte through the opening such that the electrolyte contacts the copper plated wafer, and while dispensing the electrolyte through the opening, relative movement is effected between the opening and the copper plated wafer. The opening can have a uniform width, be convex, concave, or take any other shape depending on the application. The copper plated wafer can be moved linearly across the opening and can also be rotated. The electrolyte can be delivered to a process tank having a containment device thereon which provides the opening. As such, the opening functions an overflow weir.

### RELATED APPLICATION (PRIORITY CLAIM)

This patent application is a divisional of U.S. patent application Ser. No. 10/454,944, filed on Jun. 5, 2003.

### BACKGROUND

The present invention generally relates to methods and systems for electro-polishing a copper plated wafer, and specifically relates to a method and system for electro-polishing a copper plated wafer by dispensing an electrolyte through a long opening, preferably functioning as an overflow weir.

Currently, electro-polishing of copper plated wafers is typically performed in a tool which is currently commercially available through ACM Research. The process of electro-polishing is accomplished by moving a copper plated rotating semiconductor wafer over a fixed nozzle. The fixed nozzle sprays a columated cylinder of an electrolyte fluid up towards the wafer while the wafer is rotating and moving. A current (or voltage) is applied to complete a circuit from the electrolyte nozzle through the electrolyte to the copper plated wafer. This causes a deplating or electro-polishing action on the wafer to remove excess deposited copper from the ‘field’ areas of the wafer. The problem is that due to the dynamics of the system, i.e. wafer rotation methodology, linear wafer motion, and fluid dynamics, uniform removal of the copper across the wafer cannot be achieved in a satisfactory manner. Either residue or severe ‘dishing’ of the copper wiring results. Both of these conditions are undesirable, and render the wafers useless. Center to edge uniformity of copper removal is very difficult to control using the current tool design methodology. Current nozzle diameters range form 0.25-0.5 inches. The current process utilizes this nozzle diameter to process the entire surface area of the wafer.

Many attempts to solve this problem have been attempted by changing the rotation speed of the wafer with respect to the linear distance traveled by the wafer during polishing. Another attempt at solving this problem was adding the capability to vary the linear speed of the wafer during polishing. This solution essentially tries to control the dwell time of the electrolyte at the surface of the wafer. Other machine parameters can also be changed such as current or voltage during polishing to affect the removal rate with regard to position. Due to the complex interactions of the viscosity of the electrolyte and the surface tension adhesion of the electrolyte to the surface of the wafer, electro-polishing occurs at points on the wafer when it is not desired. In most cases, due to simple laws of dynamics (point velocities of a rotating disk), these solutions continue to produce extremely non-uniform polishing.

The typical solutions which have been attempted have not addressed the complex interactions that occur with the boundry layer of electrolyte, wafer rotation velocity, linear motion of the wafer over the electrolyte, and electrolyte viscosity.

### OBJECTS AND SUMMARY

An object of an embodiment of the present invention is to provide an improved method and system for electro-polishing a copper plated wafer.

Another object of an embodiment of the present invention is to provide a method and system for achieving uniform stress free electro-polishing across a copper plated wafer.

Still another object of an embodiment of the present invention is to provide a method and system for electro-polishing a copper plated wafer without causing residue or severe “dishing” of the copper wiring.

Yet another object of an embodiment of the present invention is to provide a method and system for electro-polishing a copper plated wafer which achieves center to edge uniformity of copper removal.

Briefly, and in accordance with at least one of the foregoing objects, an embodiment of the present invention provides a method of electro-polishing a copper plated wafer. The method includes providing an opening having a longitudinal dimension, at least as long as a longitudinal diameter dimension of the copper plated wafer. The method also includes dispensing an electrolyte through the opening such that the electrolyte contacts the copper plated wafer. While dispensing the electrolyte through the opening, relative movement is effected between the opening and the copper plated wafer such that the longitudinal diameter dimension of the copper plated wafer moves across the longitudinal dimension of the opening. Because the opening is at least as long as the wafer, different areas of the wafer are exposed to the electrolyte for the same period of time as the wafer moves across the opening, thereby resulting in uniform copper removal, or polishing.

The opening can have a uniform width. Alternatively, the opening can be, for example, convex to achieve a higher volume of electrolyte flow at the center of the wafer, or can be concave to achieve a lower volume of electrolyte flow at the center of the wafer. Alternatively, the opening may take some other shape depending on the specific application and needs of the process.

Preferably, the copper plated wafer is moved across the opening while electrolyte is dispensed. The copper plated wafer is preferably moved linearly across the opening. The copper plated wafer can also be rotated as the copper plated wafer is moved across the opening.

The electrolyte can be delivered, such as pumped, to a process tank which has a containment device thereon with the opening being provided on the containment device. As such, the opening functions as an overflow weir.

Another embodiment of the present invention provides a system for electro-polishing a copper plated wafer. The system includes an opening having a longitudinal dimension, at least as long as a longitudinal diameter dimension of the copper plated wafer. The system also includes means for dispensing an electrolyte through the opening such that the electrolyte contacts the copper plated wafer and means for effecting relative movement between the opening and the copper plated wafer while dispensing the electrolyte.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 provides a block diagram which illustrates a method which is in accordance with an embodiment of the present invention;

FIG. 2 provides a side view which illustrates a system which is in accordance with an embodiment of the present invention;

FIG. 3 shows an opening having a uniform width;

FIG. 4 shows a convex opening;

FIG. 5 shows a concave opening; and

FIG. 6 is similar to FIG. 2, but provides a top view of the system.

### DESCRIPTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

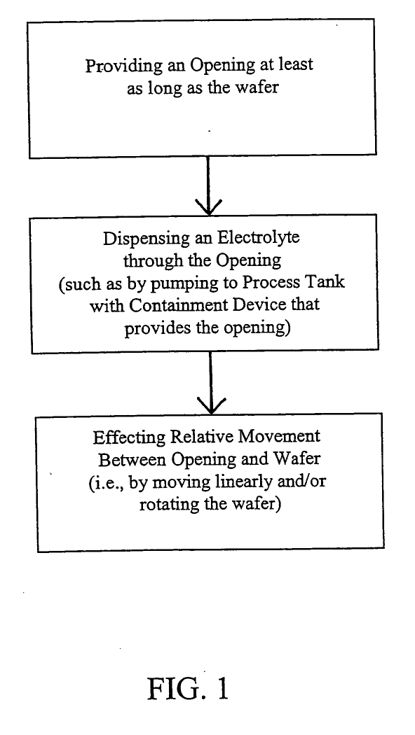

As shown in FIG. 1, an embodiment of the present invention provides a method of electro-polishing a copper plated wafer. The method includes providing an opening at least as long as the wafer. The method also provides that electrolyte is dispensed through the opening such that the electrolyte contacts the copper plated wafer. While the electrolyte is dispensed, relative movement is effected between the opening and wafer.

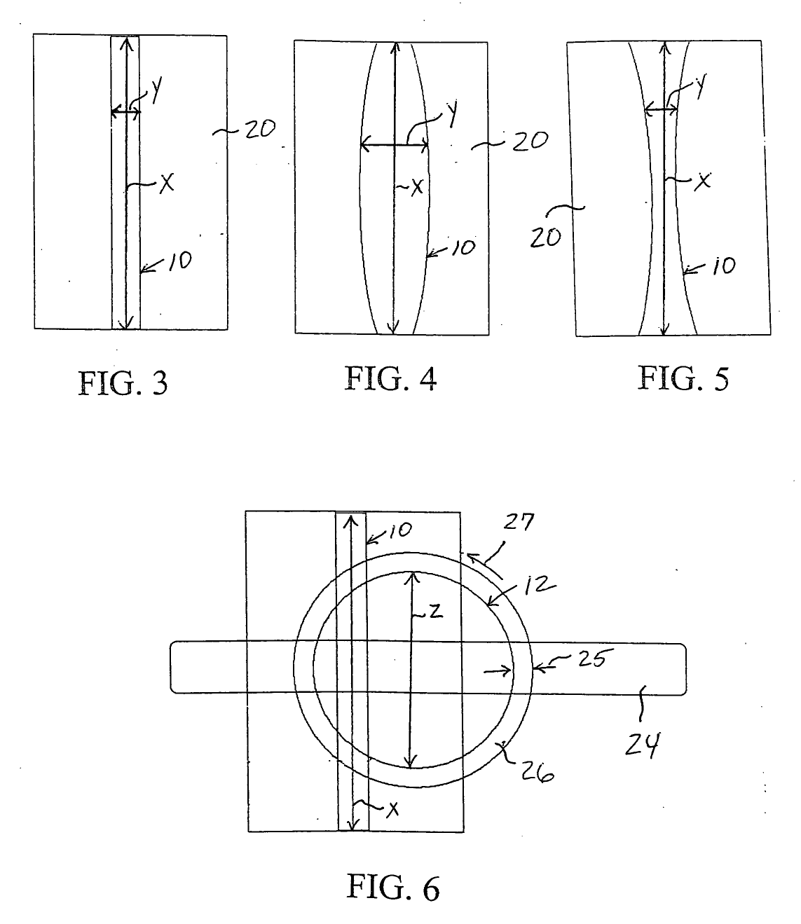

As shown in FIG. 3, the opening 10 can be provided as having a longitudinal dimension x and a uniform width y. Alternatively, as shown in FIG. 4, the opening 10 can be provided as having a longitudinal dimension x and a width y which is convex. Such a shape is preferable to achieve a higher volume of electrolyte flow at the center of the wafer. As shown in FIG. 5, the opening 10 can be provided as having a longitudinal dimension x and a width y which is concave. Such a shape is preferable to achieve a lower volume of electrolyte flow at the center of the wafer. Still further, the opening 10 can take other shapes depending on the specific application and needs of the process. Regardless, as shown in FIG. 6, preferably the opening 10 has a longitudinal dimension x which is at least as large as a longitudinal diameter dimension z of the copper plated wafer 12 as the wafer 12 is moved across the opening 10 (or, less preferably, the opening 10 is moved across the wafer). During dispensing of the electrolyte 14, a conventional electrical circuit is effected to accomplish uniform stress free electro-polishing across the wafer 12. Because the opening 10 is at least as long as the wafer 12, different areas of the wafer 12 are exposed to the electrolyte 14 for the same period of time as the wafer 12 moves across the opening 10, thereby resulting in uniform copper removal, or polishing. The opening 10 is at least as long as the copper on the wafer is, measured parallel to the opening 10, such that as the wafer 12 moves across the opening 10, all of the copper is contacted by the electrolyte 14.

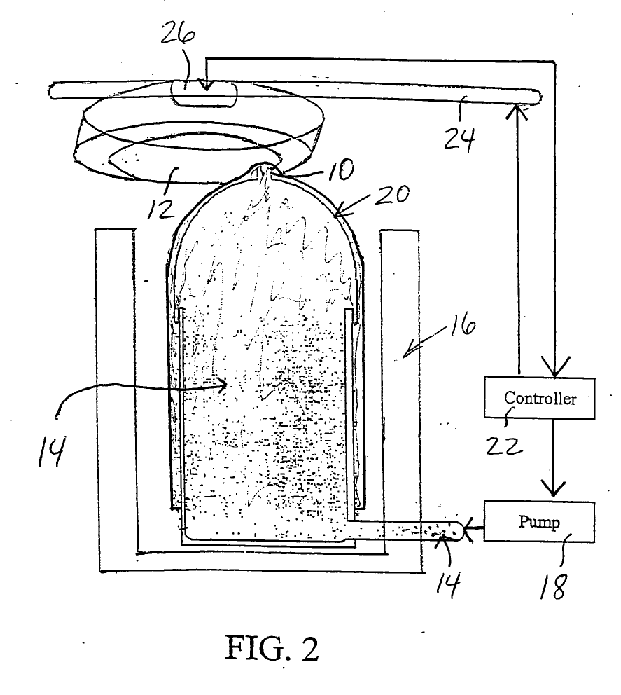

FIGS. 2 and 6 illustrate a system which is in accordance with an embodiment of the present invention and which can be used in association with the method described above and generally illustrated in FIG. 1. As shown, the system includes a process tank 16 and means, such as a pump 18, for delivering the electrolyte 14 from a temperature and viscosity controlled circulation reservoir to the process tank 16. A containment device 20 is on the process tank 16, and the containment device 20 provides the opening 10 discussed above (see FIGS. 3-5). A controller 22 is preferably in operable communication with the pump 18 as well as means 24 for linearly moving the copper plated wafer 12, such as a linear bearing type of device to drive the wafer back and forth (as indicated by arrows 25 in FIG. 6), as well as possibly means 26 for rotating the copper plated wafer (as indicated by arrow 27 in FIG. 6), such as a wafer chucking mechanism.

In use, the controller 22 controls the pump 18 to deliver electrolyte 14 to the process tank 16 such that the electrolyte 14 dispenses through the opening 10. As such, the opening 10 functions as an overflow weir. As the electrolyte 14 is dispensed through the opening 10, relative movement is effected between the opening 10 and the copper plated wafer 12. Specifically, preferably the controller 22 moves the copper plated wafer 12 linearly relatively perpendicularly across the opening 10 as well as possibly rotates the copper plated wafer 12 while moving the wafer 12 linearly.

The method and system achieves uniform stress free electro-polishing across a copper plated wafer, without causing residue or severe “dishing” of copper wiring. Preferably, the method and system achieve center to edge uniformity of copper removal. Uniform copper removal is achieved due to the different areas of the wafer being exposed to the electrolyte for the same period of time. This results in a uniform copper removal or polish rate from one point on the wafer to another. The advantage of using the method and system is that the final polished wafer has the copper uniformly removed. All areas of the wafer from edge to edge have the copper removed at the same rate. Many different weir designs can be utilized as well as different motions of the wafer across the weir to produce uniformly removed copper resulting in stress free planarization.

While an embodiment of the present invention is shown and described, it is envisioned that those skilled in the art may devise various modifications of the present invention without departing from the spirit and scope of the appended claims.

What is claimed is:

1. A method of electro-polishing a copper plated wafer having a longitudinal diameter dimension, said method comprising: providing an opening having a longitudinal dimension, said longitudinal dimension of said opening being at least as long as the longitudinal diameter dimension of the copper plated wafer; dispensing an electrolyte through said opening such that the electrolyte contacts the copper plated wafer; while dispensing the electrolyte through said opening, effecting relative movement between the opening and the copper plated wafer such that the longitudinal diameter dimension of the copper plated wafer moves across the longitudinal dimension of the opening.

2. A method as recited in claim 1, wherein the opening has a uniform width.

3. A method as recited in claim 1, wherein the opening is convex.

4. A method as recited in claim 1, wherein the opening is concave.

5. A method as recited in claim 1, wherein the step of effecting relative movement between said opening and the copper plated wafer comprises linearly moving at least one of the copper plated wafer and the opening.

6. A method as recited in claim 5, further comprising rotating the copper plated wafer.

7. A method as recited in claim 1, further comprising delivering the electrolyte to a process tank, said tank having a containment device thereon which provides the opening.
